(19) United States
(12) Patent Application Publication
(10) Pub. No.: US 2013/0286363 A1
(43) Pub. Date: Oct. 31, 2013

(54) PROJECTOR HAVING REFLECTION DEVICE

(71) Applicants: Heng LIU, Hsin-Chu (TW); Hsin-Hung Tu, Hsin-Chu (TW)

(72) Inventors: Heng LIU, Hsin-Chu (TW); Hsin-Hung Tu, Hsin-Chu (TW)

(73) Assignee: AIPTEK International Inc., Hsin-Chu (TW)

(21) Appl. No.: 13/458,835

(22) Filed: Apr. 27, 2012

(51) Int. Cl. G03B 21/28

(52) U.S. Cl. 353/98

(57) ABSTRACT

A projector having a reflection device includes a projector body and a reflection device. The projector body has a first surface and a second surface. A projection lens is disposed on the first surface. A reflection device is disposed beside the projection lens for reflecting a projected image of a mobile device connected to the projector body. Due to the reflection device, the projected image of the projector is reflected and projected, thereby allowing the path of image projection to change and go in another direction and enlarging the projected image with the reflecting mirror.

### BACKGROUND OF THE INVENTION

1. Field of the Invention

The present invention relates to projectors each having a reflection device, and more particularly, to a projector having a reflection device and being capable of changing a projection path.

2. Description of Related Art

Due to technological advancement, people nowadays often have to produce a briefing or give a presentation, whether at work or at school. To allow an audience to watch the briefing or presentation clearly, a projector serves as a common convenient means whereby the briefing or presentation is projected onto a screen and enlarged.

Due to the wide use of portable electronic devices, or known as mobile devices, such as cell phones; iPad, or tablet computers, plenty of people store a briefing or presentation in a mobile device, such that the mobile device can project a file, a picture, or data, using a projector. Conventional projectors are so bulky that they are flawed with difficulty in adjusting a projection angle and unstable display of a projected image when it is necessary to adjust the position of the image projected and displayed in order for the audience to watch the image.

Referring to FIG. 1 and FIG. 2, a conventional handheld projector 100 not only solves the problem with the bulkiness of a projector but is also coupled to a mobile device 200 to effectuate image projection. However, the commercially available mobile devices 200 are equipped mostly with a touchscreen to enhance ease of use. As a result, when operating the mobile device 200, a user holds the mobile device 200 with one hand and operates the mobile device 200 in a touch control manner with the other hand. If the user has the mobile device 200 coupled to the handheld projector 100 during the image projection process, projecting an operation frame to an appropriate position with the mobile device 200 coupled to the handheld projector 100 will cause the mobile device 200 to lie horizontally, thereby rendering it difficult to manipulate the touchscreen of the mobile device 200 in a touch control manner. If the user performs image projection by holding the mobile device 200 together with the handheld projector 100, the resultant display of the projected image will be unstable.

In view of this, it is imperative to design a projector capable of changing a projection path, such that the projector which is coupled to a mobile device can lie at an appropriate position for projecting the contents of the operation frame while the mobile device is being operated in a touch control manner.

### SUMMARY OF THE INVENTION

The present invention provides a projector having a reflection device. The projector comprises a projector body and a reflection device. The reflection device is coupled to a first surface of the projector body. The projector is capable of changing a path of image projection by means of the reflection device. The projected image is enlarged with a reflecting mirror on the reflection device.

The invention provides a projector having the reflection device, comprising: a projector body having a first surface and a second surface, wherein a projection lens is disposed on the first surface; and a reflection device, comprising: a lid coupled to the first surface with an axle and adapted to rotatably cover the projection lens; and a reflecting mirror disposed on an inner side of the lid, wherein the inner side of the lid is opposite to the first surface.

Implementation of the present invention at least involves inventive steps as follows:

1. changing the path of image projection, such that the projector projects an image to an appropriate position; and

2. enlarging the projected image through the reflection performed with the reflecting mirror.

Hereinafter, the detailed features and advantages of the present invention are described in detail by way of the preferred embodiments of the present invention so as to enable persons skilled in the art to gain insight into the technical disclosure of the present invention, implement the present invention accordingly, and readily understand the objectives and advantages of the present invention by making reference to the disclosure of the specification, the claims, and the drawings of the present invention.

### BRIEF DESCRIPTION OF THE SEVERAL VIEWS OF THE DRAWINGS

FIG. 1 (Prior art) is a perspective view of a conventional projector;

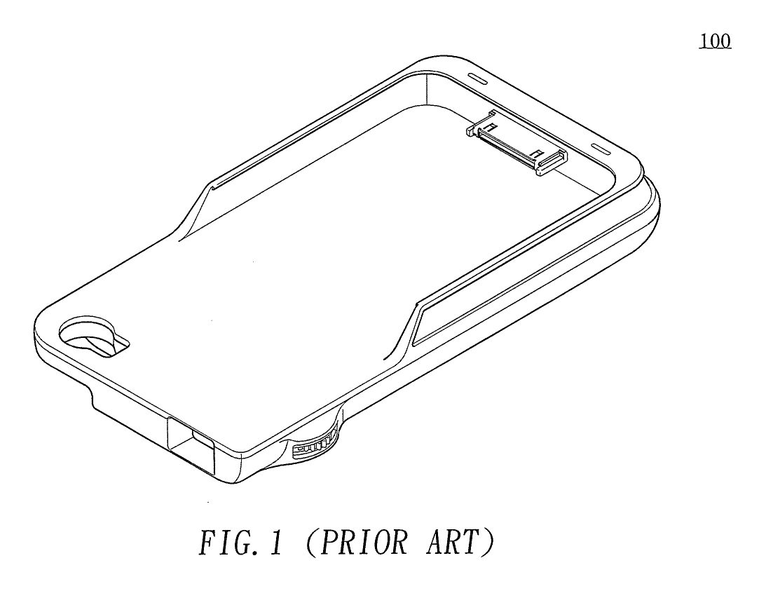

FIG. 2 (Prior art) is a perspective view of a conventional projector having a mobile device coupled thereto;

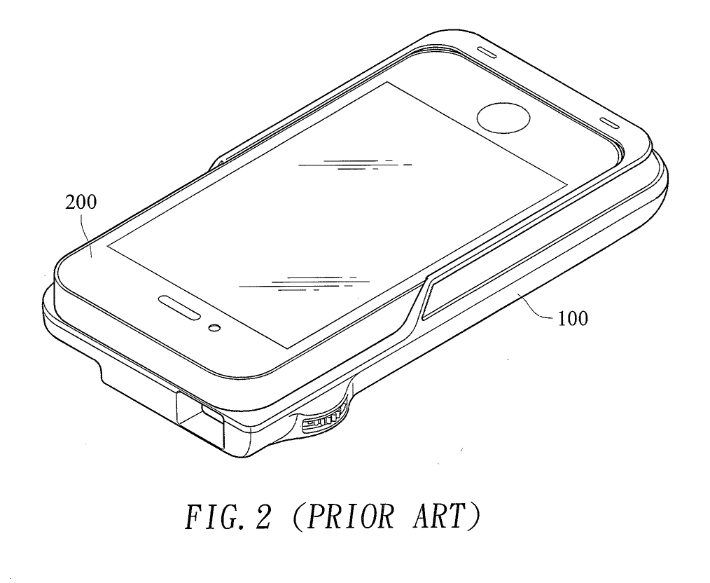

FIG. 3 is a perspective view of a projector having a reflection device according to an embodiment of the present invention;

FIG. 4 is a side view of the projector having a reflection device according to an embodiment of the present invention;

FIG. 5 is a perspective view of the projector having a reflection device and coupled to a mobile device according to an embodiment of the present invention;

FIG. 6 is the application aspect 1 of the projector according to an embodiment of the present invention;

FIG. 7 is the application aspect 2 of the projector according to an embodiment of the present invention;

FIG. 8 is the application aspect 3 of the projector according to an embodiment of the present invention; and

FIG. 9 is the application aspect 4 of the projector according to an embodiment of the present invention.

### DETAILED DESCRIPTION OF THE EMBODIMENTS OF THE INVENTION

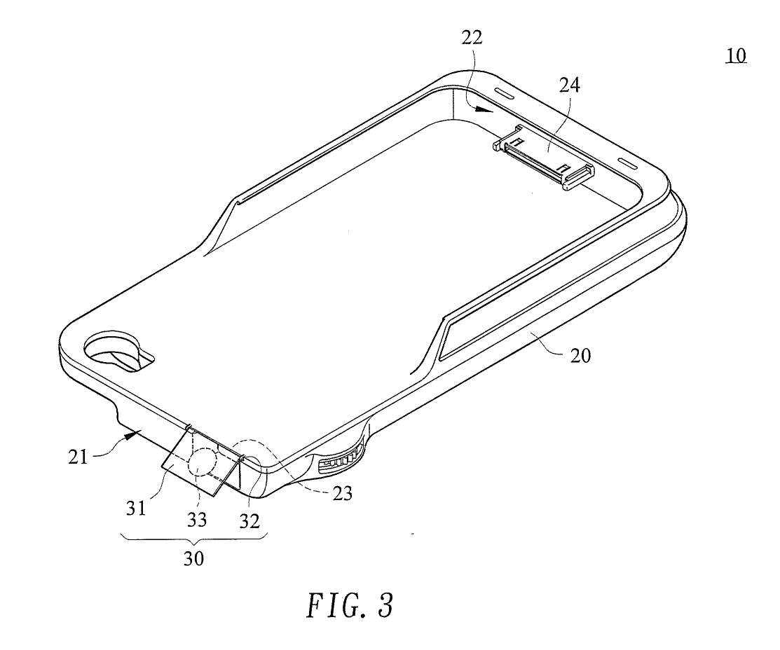

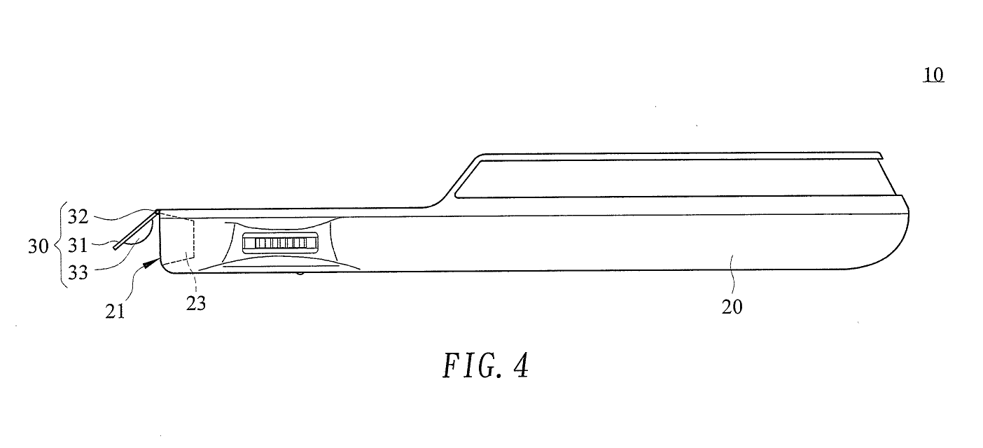

Referring to FIG. 3 through FIG. 5, in this embodiment, a projector 10 having a reflection device comprises a projector body 20 and a reflection device 30.

The projector body 20 is a projector and has a first surface 21 and a second surface 22. The first surface 21 is a plane on the front of the projector body 20. A projection lens 23 is disposed on the first surface 21 for performing image projection and display by, for example, projecting an image onto a wall or a fabric projector screen. A connector 24 is disposed on the second surface 22 of the projector body 20. The second surface 22 is an inner surface formed by extending upward a peripheral portion of the upper surface of the projector body 20.

The connector 24 comes in the form of an embedded connector and thus is directly embedded in a mobile device 200 to provide connection therewith. The mobile device 200 transmits image projection information to the projector body 20 via the connector 24. The mobile device 200 is a smartphone; hence, once the smartphone gets connected to the projector body 20 via the connector 24, the operation contents displayed on the smartphone can be projected and displayed by means of the projector body 20.

The reflection device 30 is disposed on the first surface 21, positioned proximate to the projection lens 23, and adapted to change the path of image projection of a frame projected from the projection lens 23. The reflection device 30 comprises a lid 31 and a reflecting mirror 33.

The lid 31 is a plate. The lid 31 is pivotally coupled to the first surface 21 about an axle 32. The lid 31 covers the projection lens 23 when shut, so as to protect the projection lens 23, prevent dust from falling on the projection lens 23, and preclude collision-induced damage. The lid 31 is rotatable about the axle 32 freely by an adjustable angle to open or shut the lid 31. The lid 31 is made of a high-density plastic or a metal. With the lid 31 being made of a rigid material, the lid 31 is effective in protecting the projection lens 23 and thus extending the service life of the projection lens 23.

The reflecting mirror 33 is disposed on the inner side of the lid 31. If the lid 31 is shut, the reflecting mirror 33 will correspond in position to the projection lens 23 and face to it. If the lid 31 is opened to a specific angle, an image projected from the projection lens 23 will be reflected off the reflecting minor 33 to reach an intended position. Hence, once the mobile device 200 gets connected to the projector body 20, the user can operate the screen of the mobile device 200 in a touch control manner and adjust the angle by which the lid 31 is opened. Hence, image projection undergoes reflection, and thus a frame displayed on the mobile device 200 is projected to an appropriate position.

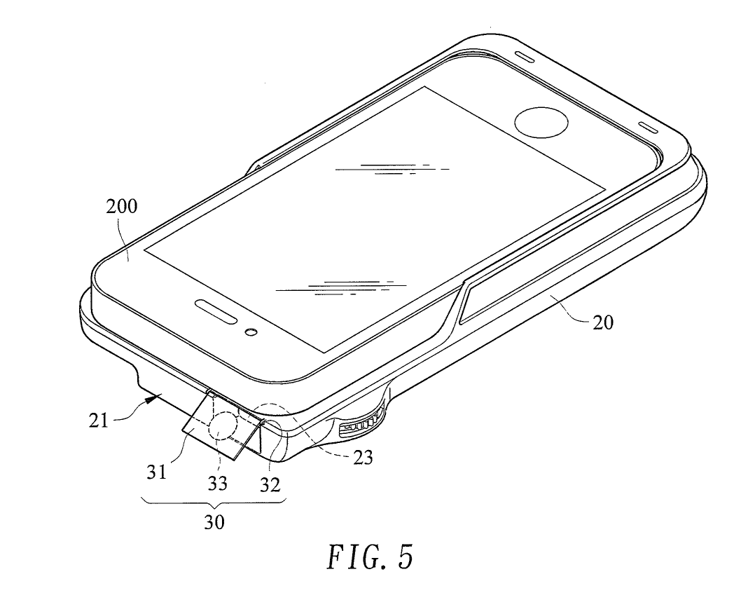

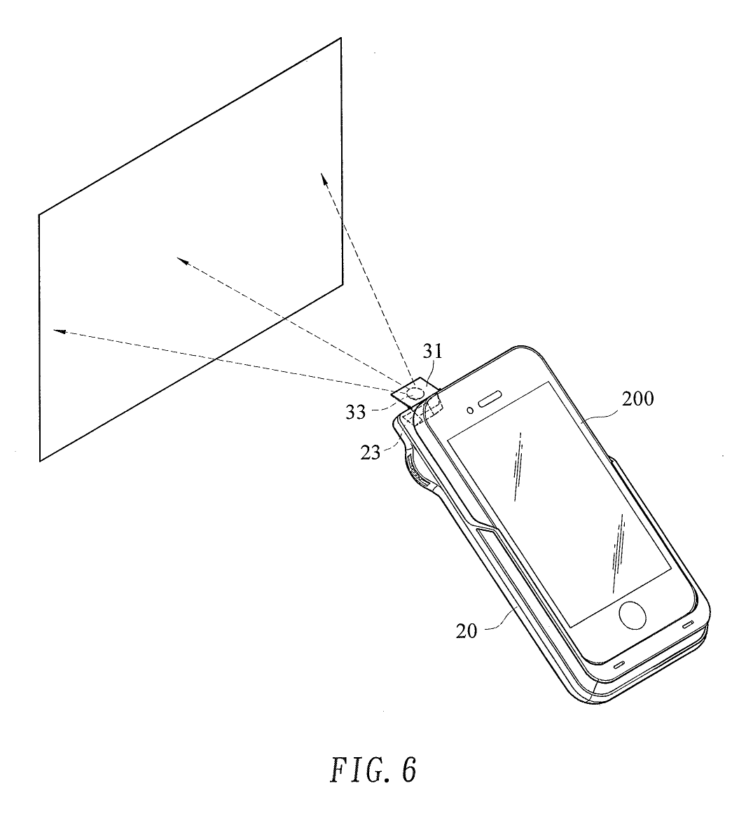

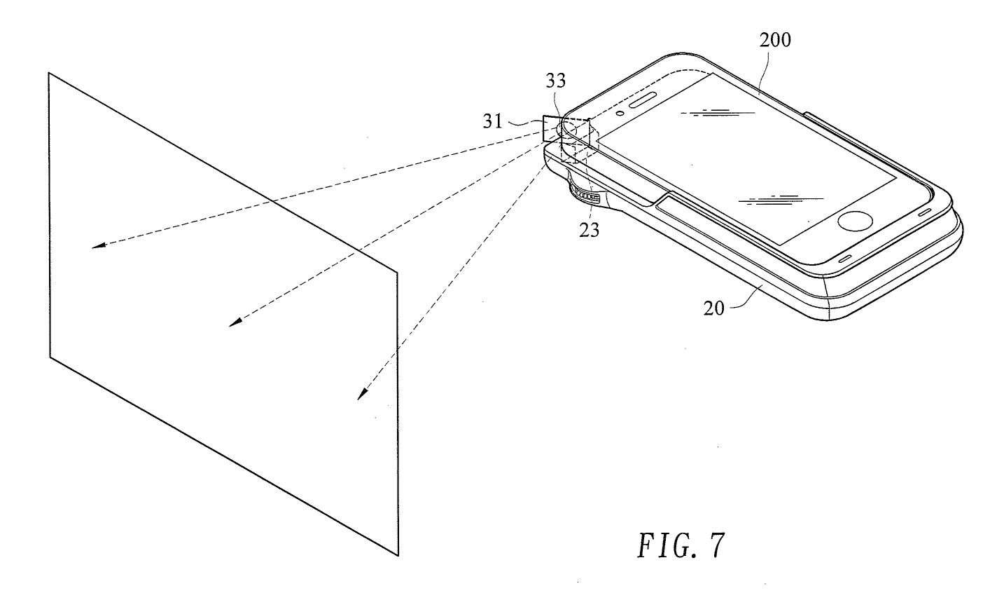

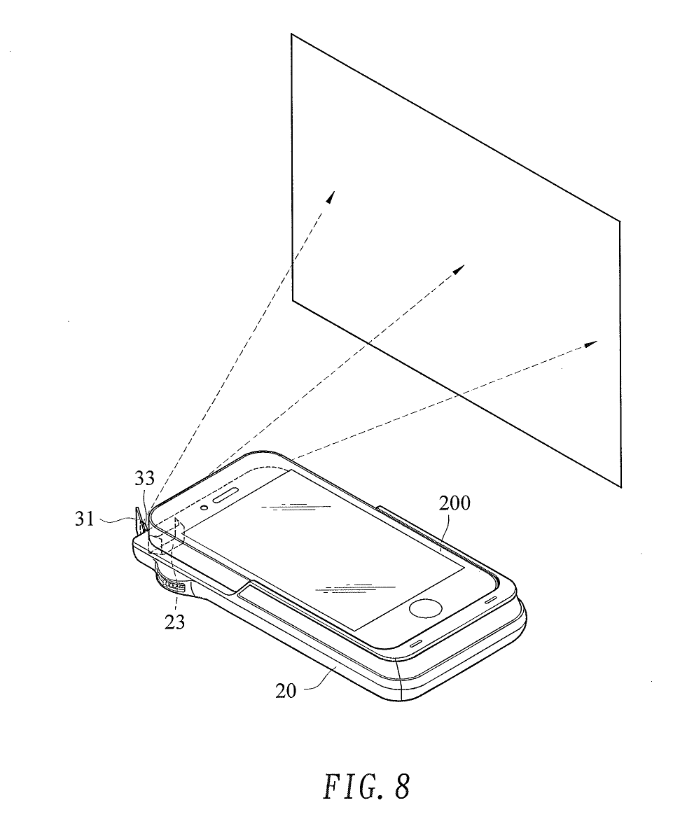

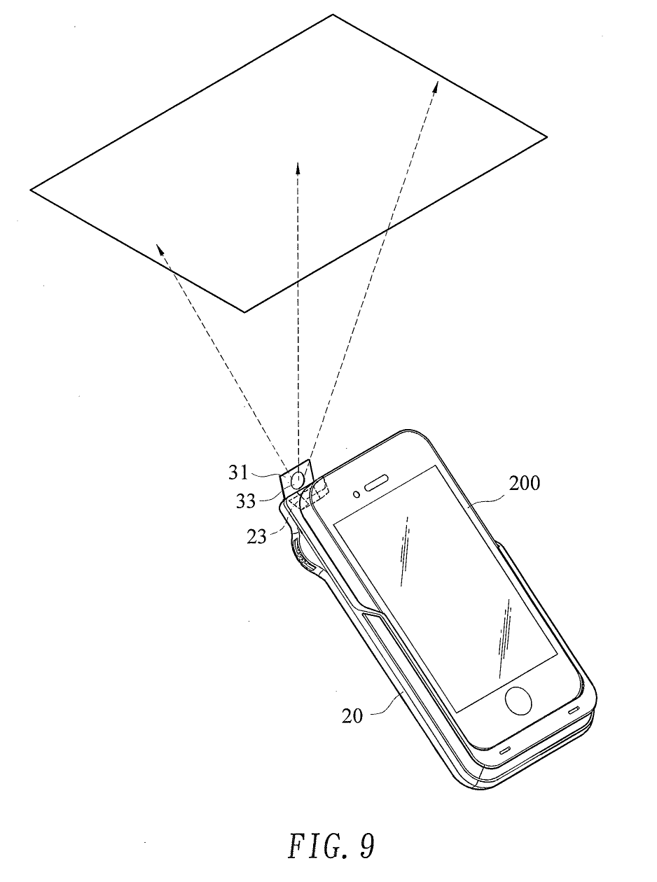

Referring to FIG. 5 through FIG. 9, the lid 31 can be disposed on the front, the left side, the right side, or the top of the projection lens 23, and thus the projected image can be longitudinally or transversely projected to an intended position. For example, to project an image onto the front of the projection lens 23, the user puts the axle 32 above the projection lens 23, such that the lid 31 is connected to the top of the projection lens 23, thereby allowing the reflecting mirror 33 to reflect an image to the front. To project an image onto the left side of the projection lens 23, the user puts the axle 32 on the right side of the projection lens 23, such that the lid 31 is connected to the right side of the projection lens 23, thereby allowing the reflecting mirror 33 to reflect an image to the left side.

To project an image onto the right side of the projection lens 23, the user puts the axle 32 on the left side of the projection lens 23, such that the lid 31 is connected to the left side of the projection lens 23, thereby allowing the reflecting mirror 33 to reflect an image to the right side. To project an image onto the ceiling, the user puts the axle 32 beneath the projection lens 23, such that the lid 31 is connected to the bottom of the projection lens 23, thereby allowing the reflecting mirror 33 to reflect an image to the ceiling. Hence, the projector body 20 can change the path of image projection.

The reflecting mirror 33 is a convex mirror. An image, which is projected from the projection lens 23 through the convex minor, is enlarged by means of the convex mirror, such that the audience can watch the projected image clearly.

The features of the present invention are disclosed above by the preferred embodiments to allow persons skilled in the art to gain insight into the contents of the present invention and implement the present invention accordingly. The preferred embodiments of the present invention should not be interpreted as restrictive of the scope of the present invention. Hence, all equivalent modifications or amendments made to the aforesaid embodiments should fall within the scope of the appended claims.

What is claimed is:

1. A projector having the reflection device, comprising:
a projector body having a first surface and a second surface, wherein a projection lens is disposed on the first surface; and
a reflection device, comprising:
a lid coupled to the first surface with an axle and adapted to rotatably cover the projection lens; and
a reflecting mirror disposed on an inner side of the lid, wherein the inner side of the lid is opposite to the first surface.

2. The projector of claim 1, wherein a connector is disposed on the second surface for connection with a mobile device.

3. The projector of claim 2, wherein the mobile device is a smartphone.

4. The projector of claim 1, wherein the lid is disposed on a lateral side of the projection lens.

5. The projector of claim 1, wherein the lid is made of a plastic or a metal.

6. The projector of claim 1, wherein the reflecting mirror is a convex mirror.
